(19) United States
(12) Patent Application Publication
(10) Pub. No.: US 2011/0194709 A1
(43) Pub. Date: Aug. 11, 2011

(54) Automatic source separation via joint use of segmental information and spatial diversity

(75) Inventors: Alexey Ozerov, Rennes (FR); Raphael Blouet, Saint Ouen (FR); Cédric Févotte, Paris (FR)

(73) Assignees: AUDIONAMIX; INSTITUT TELECOM -TELECOM PARISTECH; CENTRE NATIONAL DE LA RECHERCHE SCIENTIFIQUE

(21) Appl. No.: 13/021,692

(22) Filed: Feb. 4, 2011

Related U.S. Application Data
(60) Provisional application No. 61/302,073, filed on Feb. 5, 2010.

(51) Int. Cl. H04B 1/00

(52) U.S. Cl. 381/119

(57) ABSTRACT

A source separation system is provided. The system includes a plurality of sources being subjected to an automatic source separation via a joint use of segmental information and spatial diversity. The system further includes a set of spectral shapes representing spectral diversity derived from the automatic source separation being automatically provided. The system still further includes a plurality of mixing parameters derived from the set of spectral shapes. Within a sampling range, a triplet is processed wherein a reconstruction of a Short Term Fourier Transform (STFT) corresponding to a source triplet among the set of triplets is performed.

### REFERENCE TO RELATED APPLICATIONS

This application claims an invention which was disclosed in Provisional Patent Application No. 61/302,073, filed Feb. 5, 2010, entitled “AUTOMATIC SOURCE SEPARATION DRIVEN BY TEMPORAL DESCRIPTION AND SPATIAL DIVERSITY OF THE SOURCES”. The benefit under 35 USC §119(e) of the above mentioned United States Provisional Applications is hereby claimed, and the aforementioned application is hereby incorporated herein by reference.

### FIELD OF THE INVENTION

This invention relates to an apparatus and methods for digital sound engineering, more specifically this invention relates to an apparatus and methods for Automatic Source Separation driven by the joint use of a temporal description of audio components within a mixture and spatial diversity of the sources.

### BACKGROUND

Source separation is an important research topic in a variety of fields, including speech and audio processing, radar processing, medical imaging and communication. It is a classical but difficult problem in signal processing. Generally, the source signals as well as their mixing characteristics are unknown and attempts to solve this problem require making some specific assumptions either on the mixing system, or the sources; or both.

According to the available information on the intrinsic structure of the mixture, several systems for source separation are found in the prior art literature on source separation. Method and apparatus for blind separation of mixed and convolved sources are known. In U.S. patent application Ser. No. 08/893,536 to H. Attias. Entitled “Method and apparatus for blind separation of mixed and convolved sources” (hereinafter merely Attias II) describes such a method and apparatus which was filed: Jul. 11, 1997 and issued: Feb. 6, 2001. Attias II is hereby incorporated herein by reference.

Nonnegative sparse representation for Wiener based source separation with a single sensor is known. In IEEE International Conference on Acoustics, Speech, and Signal Processing (ICASSP), 2003 to L. Benaroya, L. Mc Donagh, F. Bimbot, and R. Gribonval entitled “Nonnegative sparse representation for Wiener based source separation with a single sensor (hereinafter merely Benaroya)” describes such a separation with a single sensor. Benaroya is hereby incorporated herein by reference.

Blind source separation of disjoint orthogonal mixture: Demixing N sources from 2 mixtures is known. In IEEE International Conference on Acoustics, Speech, and Signal Processing (ICASSP), pages 2985-88, 2000 to A. Jourjine, S. Rickard, and O. Yilmaz. “Blind source separation of disjoint orthogonal mixture: Demixing N sources from 2 mixtures” (hereinafter merely Jourjine) describes such a Blind source separation. Jourjine is hereby incorporated herein by reference.

Multichannel nonnegative matrix factorization in convolutive mixtures for audio source separation is known. In “Multichannel nonnegative matrix factorization in convolutive mixtures for audio source separation” by A. Ozerov and C. Févotte (hereinafter merely Ozerov I) describes such a multichannel nonnegative matrix factorization. See IEEE Transaction on Audio, Speech and Language Processing special issue on Signal Models and Representations of Musical and Environmental Sounds, 2009. Ozerov I is hereby incorporated herein by reference.

Algorithms for Non-negative Matrix Factorization are known. In “Algorithms for Non-negative Matrix Factorization” to D. Lee, H.-S. Seung, (hereinafter merely Lee) describes such an algorithm. See Advances in Neural Information Processing Systems, 2001. Lee is hereby incorporated herein by reference.

Maximum likelihood from incomplete data via the EM algorithm is known. In “Maximum likelihood from incomplete data via the EM algorithm” to A. Dempster, N. Laird, and D. Rubin (hereinafter merely Dempster) describes such an algorithm. See Journal of the Royal Statistical Society, Series B, 39(1):1-38, 1977. Dempster is hereby incorporated herein by reference.

One microphone singing voice separation using source-adapted models is known. In “One microphone singing voice separation using source-adapted models” to A. Ozerov, P. Philippe, R. Gribonval and F. Bimbot, (hereinafter merely Ozerov II) describes such a model. See IEEE Workshop on Apps. of Signal Processing to Audio and Acoustics (WASPAA'05), pages 90-93, Mohonk, N.Y., Oct. Ozerov II is hereby incorporated herein by reference.

Structured non-negative matrix factorization with sparsity patterns is known. In “Structured non-negative matrix factorization with sparsity patterns” by Hans Laurberg, Mikkel N. Schmidt, Mads G. Christensen, and Søren H. Jensen (hereinafter merely Laurberg) describes such a non-negative matrix factorization. See Signals, Systems and Computers, Asilomar Conference on, 2008. Laurberg is hereby incorporated herein by reference.

Musical audio stream separation by non-negative matrix factorization is known. In “Musical audio stream separation by non-negative matrix factorization” by B. Wang and M. D. Plumbley (hereinafter merely Wang) describes such an audio stream separation. See Proceedings of the DMRN Summer Conference, Glasgow, 23-24 Jul. 2005. Wang is hereby incorporated herein by reference.

Methods and apparatus for blind separation of convolved and mixed sources are known. For example, U.S. Pat. No. 6,185,309 to Attias hereinafter referred to merely as Attias I describes a method and apparatus for separating signals from instantaneous and convolutive mixtures of signals. In Attias I a plurality of sensors or detectors detect signals generated by a plurality of signal generating sources. The detected signals are processed in time blocks to find a separating filter, which when applied to the detected signals produces output signals that are estimated of separated audio component within the mixture. Attias I is hereby incorporated herein by reference.

A source separation method is a signal decomposition technique. It outputs a set of homogeneous components hidden in observed mixture(s). One such component is referred to as “separated source” or “separated track”, and is ideally equal to one of the original source signal that produced the recordings. More generally it is only an estimate of one of the source as perfect separation is usually not possible.

Depending on the available number of observed signals and sources, the problem can be either over-determined (at least as many mixtures than sources) or underdetermined (less mixtures than sources).

Depending on the physical mixing process that produced the observed signals, the mixture (provided it is linear) can be either instantaneous or convolutive. In the first case each sample of the observed signals at a given time is simply a linear combination over each source of sample at the same time. The mixing is convolutive when each source signal is attenuated and delayed, in some unknown amount, during passage from the signal production device to the signal sensor device, generating a so called multi-path signal. The observed signal hence corresponds to the mixture of all multi-path signals.

As can be seen, various source separation systems can be found in the literature including the above listed. They all rely on specific assumptions about the mixing system and the nature of the sources. In multichannel settings prior art methods tend to exploit spatial diversity to discriminate between the sources, see, e.g, Jourjine. As spatial information is not available when only one mixture is available, prior art methods in this setting rely on discrimination criteria based source structure. In particular, diversity of the source activations in time (loosely speaking, the fact that they are likely not to be constantly simultaneously active) forms structural information that can be exploited for single-channel source separation see Ozerov II, or Laurberg.

Many source separation methods, and in particular the above-mentioned ones, are based on a short-time Fourier transform (STFT) representation of the sources, as opposed to working on the time signals themselves. This is because most signals, and in particular audio signals, exhibit a convenient structure in this transformed domain. They may be considered sparse, i.e, most of the coefficients of the representation have weak relative energy, a property which is exploited, e.g, by Jourjine. Furthermore, they might be considered stationary on short segments, typically of size of the time-window used to compute the time-frequency transform. This property is exploited in Attias, Ozerov I, Ozerov II, or Laurberg.

According to the prior art, a standard source separation technique that allows the separation of an arbitrary number of sources from 2 (two) observed channels is presented in Jourjine and described in FIG. 1. The proposed source separation method assumes that the sources do not overlap in the time-frequency plane. This is likely the case for sparse and independent signals such as speech. The mixing parameters are retrieved from an estimation of the spatial distribution of the sources. The mixing parameters are then used to discriminate between the sources in each time-frequency cell, and thus perform separation. However it is worth pointing out that:
1. This method fails in the case of convolutive mixture (it only allows an attenuation+delay).
2. This method fails if sources overlap in the time-frequency plane, and
3. This method is designed for only two sensors.

Providing segmental information to the algorithm may improve the separation results but would not in any case alleviate these shortcomings.

The method presented in Attias and described in FIG. 2 remedies these limitations. There, convolution is routinely approximated as linear instantaneous mixing in each frequency band, an assumption that holds when the length of the STFT window is significantly shorter than the length of the convolution. The method does not assume non-overlap of the sources in the STFT plane per se. Each source STFT frame is modeled through a set of given pre-trained spectral shapes, via Gaussian Mixture Model (GMM), characterizing the sources to separate. The spectral shapes form a basis for discriminating between the sources in each STFT frame. It is worth pointing the following limitations of this method:
1. It assumes that the nature of sources in the mixtures is known, and that GMM parameters have been pre-trained on appropriate training data, prior to separation. In contrast, our method does not make such an assumption, and
2. The source model does not include amplitude parameters in each frame of the STFT, accounting for energy variability of the sources.

In single-channel settings spatial diversity is not available. As such separation methods need to rely on other information to discriminate between the sources. According to the prior art, a source separation technique that allows the separation of an arbitrary number of sources from only one observed signal is presented in Benaroya and described in FIG. 3. The proposed source separation method assumes the knowledge of the number of components within the mixture as well as a model of their spectral features. The source separation system described in Benaroya assumes a complete knowledge of the spectral shapes set possibly produced by each source. For each mixture time frame, the system actives the best matching spectral shapes from the whole source spectral shape set and infers each source contribution within the mixture. This method is efficient even with sources showing strong time-frequency overlap. However it is worth pointing out that performance of this method is not robust regarding the definition of the spectral-shapes (complexity, etc.). The complete knowledge of the spectral shapes set possibly produced by each source is a prohibitive assumption that often fails.

To alleviate this strong assumption, some methods have considered the idea of adapting part of the spectral shapes to the mixture itself, given appropriate segmental information. E.g, Ozerov II considers the problem of separating singing voice from music accompaniment in single-channel recording. The music spectral shapes are learnt from the mixture itself, on parts where the voice is inactive. Then the voice spectral shapes are adapted to the mixture, given the music spectral shapes, on segments where voice and music are simultaneously present. The method hence assumes that a segmentation of the mixture in “music only” and “voice+music” parts is available. It is worth pointing out the following limitations of this method:
1. it is designed for single-channel data,
2. it is designed for voice/music separation and is not straightforwardly extendable to separation of more than two sources, and
3. the adaptation of the voice spectral shapes is done given the music spectral shapes (i.e, sequentially), as opposed to a joint adaptation. This means that the errors made in the estimation of the music model are propagated to the voice model.

Therefore, there exists a needed for an improved a source separation system over prior art system.

### SUMMARY OF THE INVENTION

There is provided a source separation system or method in which no prior information is required.

There is provided a source separation system or method wherein systems or methods are able to jointly take into account (spatial and segmental) or (spatial, segmental and spectral) sources diversity to efficiently estimate separated sources.

There is provided a source separation system or method wherein no prior information on the spectral characteristics of the sources within the mixture is required.

There is provided a source separation system or method wherein no prior information is required besides temporal description/segmentation of the sources

There is provided a source separation system or method wherein devices therein jointly take into account (spatial and segmental) or (spatial, segmental and spectral) sources diversity to efficiently estimate separated sources.

A source separation system is provided. The system includes a plurality of sources being subjected to an automatic source separation via a joint use of segmental information and spatial diversity. The system further includes a set of spectral shapes representing spectral diversity derived from the automatic source separation being automatically provided. The system still further includes a plurality of mixing parameters derived from the set of spectral shapes. Within a sampling range, a triplet is processed wherein a reconstruction of a Short Term Fourier Transform (STFT) corresponding to a source triplet among the set of triplets is performed.

There is provided a source separation system or method wherein third party information on each source's temporal activation is required.

A method is provided that comprises:
A module to extract the STFT vectors from an observed mono or stereo audio mixture.
A module (Graphic User Interface or automatic system) to define the number of audio components of interest and their respective activation time.

A module to estimate the separated sources thanks to an algorithm that enable to jointly take into account spatial and temporal diversity of the audio component within the mixture.

Note that besides the given information of the source timecodes our method is fully “blind” in the sense that no other information is needed, in particular about the spectral shapes defining the sources nor the mixing system parameters.

The implementation of our invention relies on a general expectation-maximization (EM) algorithm Dempster, similar to Ozerov I. However we have produced new (and faster) update rules for Wⱼ and Hⱼ, having a multiplicative structure, i.e., each coefficient of the matrices is updated as its previous value multiplied by a positive update factor. This has the advantage of keeping to zero the null coefficients in Hⱼ.

The automatic source separation algorithm of the invention is characterized by:

It implements an original algorithm that is able to jointly take into account the spatial and segmental information of the sources within a mixture

it implements an original algorithm that is able to jointly take into account the spatial, spectral and segmental information of the sources within a mixture the proposed source separation method enables to separate N sources (N>1) from a monophonic recording unlocking some limitations of the state of the art:
requiring prior knowledge about each source model (cf. Method related in FIG. 3)
requiring to manually bind elementary components to reconstruct the sources (cf. Method related in FIG. 4)

The proposed source separation method enables to separate N sources (N>1) from a stereo recording from instantaneous and convolutive mixture unlocking limitations of the state of the art:
restrictive hypothesis on the mixture structure (cf. Method related in g for knowledge about
each source model (cf. Method related in FIG. 2)

The Nonnegative Matrix Factorization implemented in the proposed invention takes advantage of the segmental information about the sources within the mixture to efficiently initialize the iterative estimation algorithm.

The Nonnegative Matrix Factorization implemented in the proposed invention takes advantage at each step of the provided segmental information and estimates spatial information to estimate separated sources.

Source separation consists in recovering unknown source signals given mixtures of these signals. The source signals are often more simply referred to as “sources” and the mixtures may also be referred to as “observed signals”, “detected signals” or “recordings”. The present invention brings efficiency and robustness to automatic signal source separation. More particularly it provides a method and apparatus for the estimation of the homogeneous components defining the sources. This invention is related to a method and apparatus for separating source signals from instantaneous and convolutive mixtures. It primarily concerns multichannel audio recordings (more than one detected signals) but is also applicable to single-channel recordings and non-audio data. The proposed source separation method is based on: (1) one or several sensors or detectors that detect one or several mixture signals generated by the mixture of all signals created by each source and (2) on a temporal characterization of the detected signals. The detected signals are processed in time blocks which are all tagged. The tags characterize each source presence or absence within a block. In the case of audio mixtures, the tags define the orchestration of each block such that “this block contains guitar”, “this block contains voice and piano”. The tags can be obtained through an adequate automatic process, provided by a description file, or defined manually by an operator. The tagged time blocks are also referred to as “segmental information”. Both time blocks and tags allow to find a separating filter, which when applied on the detected signals produces output signals that contain estimates of the source contributions into the detected mixture signals.

The novelty of the invention comes with the definition of an original method and apparatus which is able to take into account temporal and spatial information about the sources within the mixture. The term “spatial” refers to the fact that the sources are mixed differently in each mixture, stemming from the image of various sensors placed at various locations and recording source signals originating from various locations. The invention is however not limited to such settings and applies to synthetically mixed signals such as professionally produced musical recordings. Our method contrast to prior art approaches that have either considered spatial based separation in multichannel settings (more than one recording) or use of segmental information in single-channel settings (only one recording), but not both. The method and apparatus we propose jointly use time and space information in the separation process.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an example of a first prior art source separation system.

FIG. 2 is an example of a second prior art source separation system.

FIG. 3 is an example of a third prior art source separation system.

FIG. 4 is an example of a fourth prior art source separation system.

FIG. 5A is an example of a source separation system according to the present invention. FIG. 5B is an example of a set of source estimation blocks in accordance with the present invention.

FIG. 6 is an example of a fifth prior art source separation system according to prior art described for instance in Ozerov II. This system is limited to the separation of two sources. It requires prior segmental information on both sources. It estimates prior model of each source using segments where there is no more than one source active. Spectral and segmental information are sequentially taken into account and the proposed system is not able to take into account spatial diversity.

FIG. 7 is an example of a sixth prior art source separation system according to prior art described for instance in Laurberg.

FIG. 8 is an example of a seventh prior art source separation system according to prior art described for instance in Ozerov I. No prior information is required, the system is able to take advantage of sources' spatial and spectral diversities but it is limited by its inability to take advantage of segmental information. This drawback is overcome by the new source estimation algorithm of the proposed invention

FIG. 9 is a flowchart of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to signal processing. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element

The proposed invention is based on the source models proposed in Benaroya. The power spectrogram (i.e, the squared magnitude of the STFT) of each source is modeled as a non-subtractive linear combination of elementary spectral shapes, a model which shares connection to nonnegative matrix factorization (NMF) Lee of the source power spectrogram. Thanks to the nonnegative constraints, NMF allows intuitive part-based decomposition of the spectrogram. If |Sⱼ|² denotes the power spectrogram, of dimension F×N, of source j, the model reads:

|Sⱼ|²≈WⱼHⱼ

where Wⱼ is matrix of dimensions F×K containing the spectral shapes and Hⱼ is a matrix of dimensions K×N, containing the activation coefficients (thus accounting for energy variability). Instead of pre-training source models Wⱼ as in Benaroya, we propose to learn the models (spectral shapes and activation coefficients) directly from the mixtures. To do so, we assume segmental information about the activation of the individual sources to be available in a “timecode” file, produced either from manual annotation or automatic segmentation. The file solely indicates the regions where a given source is active or not. In our invention this information is reflected in the matrix Hⱼ, by setting coefficients corresponding to inactive regions to zero. Our algorithm keeps these coefficients to zero throughout the estimation process, and the estimation of the spectral shapes Wⱼ is thus driven by the presence of these zeros. In other words, Wⱼ is the characteristic of source j. Note that as opposed to Ozerov II, the spectral shapes W₁ . . . W_{J} for all sources are learnt jointly, as opposed to sequentially. The concept of using structured matrices Hⱼ has been employed in Laurberg for spectral shape learning. The setting is as in Benaroya, single channel source separation is performed given the source-specific dictionaries W₁ . . . W_{J}. However Laurberg shows that instead of learning each dictionary Wⱼ on some training set containing only one type of source, the dictionaries W₁ . . . W_{J} can be learnt together given a set of training signals composed of mixture of sources, whose respective activations satisfy certain conditions.

Our invention implements a multichannel version of the method described in the previous paragraph, so that segmental information can be used jointly with spatial diversity, for increased performance. Our invention is suitable for both instantaneous and convolutive mixtures. In the latter case, the time-domain convolution is approximated by instantaneous mixing in each frequency band.

Given source activation time-codes, i.e., structured Hⱼ, our invention estimates the nonzero coefficients in the matrices H₁ . . . H_{J}, the source spectral shapes W₁ . . . W_{J} and the convolutive mixing parameters. Time-domain estimates of the sources may then be reconstructed from the estimated parameters. Note that besides the given information of the source timecodes, our method is fully “blind” in the sense that no other information is needed, in particular about the spectral shapes defining the sources nor the mixing system parameters.

The implementation of our invention relies on a generalized expectation-maximization (EM) algorithm in Dempster, which is similar to Ozerov I. However we have produced new (and faster) update rules for W_{J} and H_{J}, having a multiplicative structure, i.e., each coefficient of the matrices is updated as its previous value multiplied by a positive update factor. This has the advantage of keeping to zero the null coefficients in H_{J}.

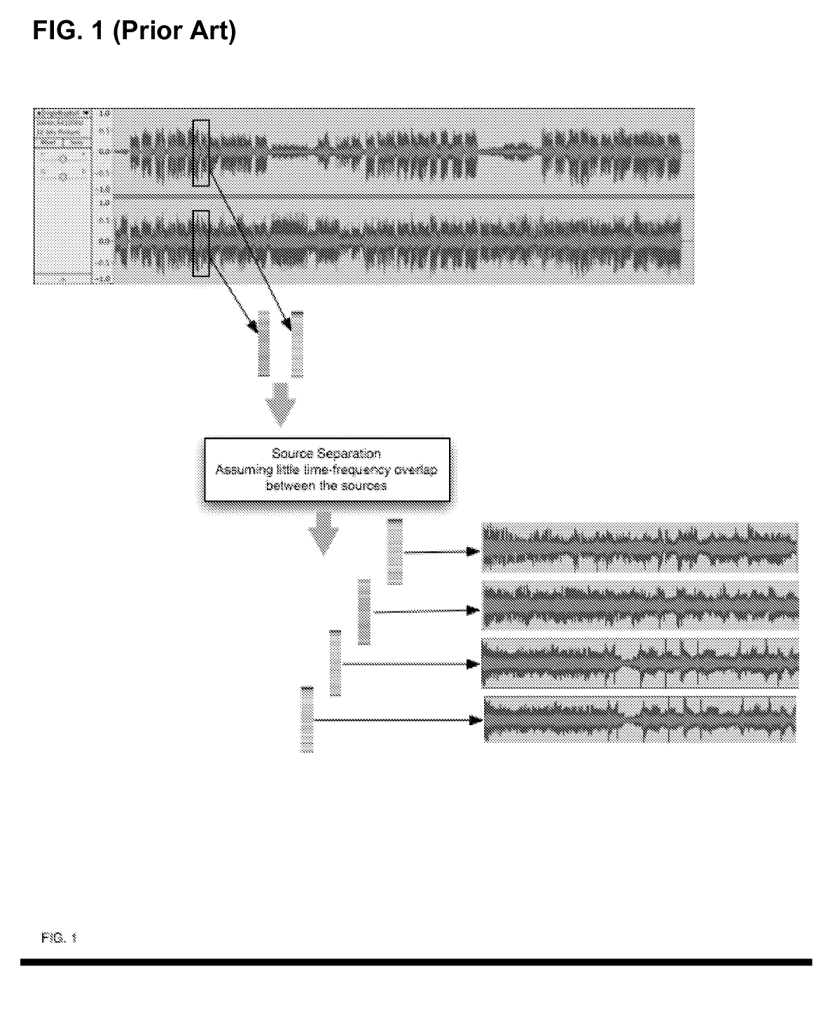

Referring to FIG. 1, a first prior art source separation system as described in Jourjine is shown. Note that no prior information is required but the system tends to make strong and sometimes wrong assumptions about the mixture structure.

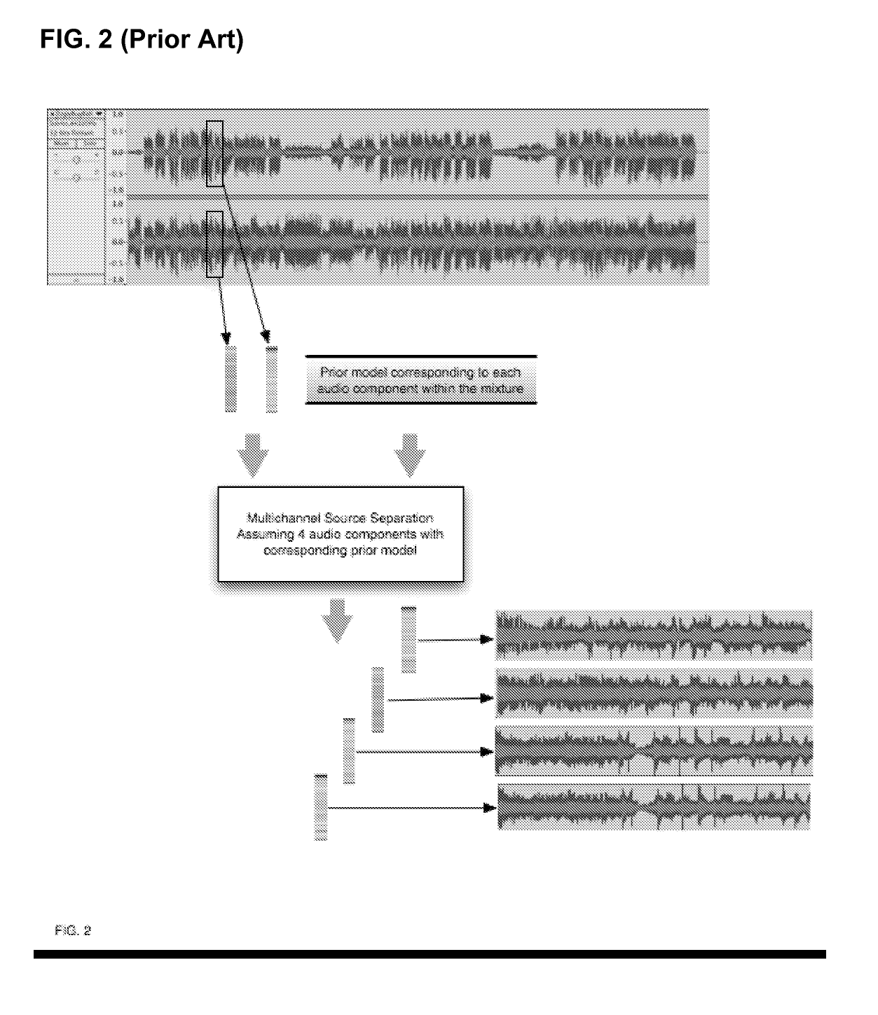

Referring to FIG. 2, a second prior art source separation system described for instance in Attias is shown. This system requires prior information about the sources within the mixture. This prior information can be very difficult to obtain. The system is not able to deal with energy changes between training sources and sources observed through the mixture.

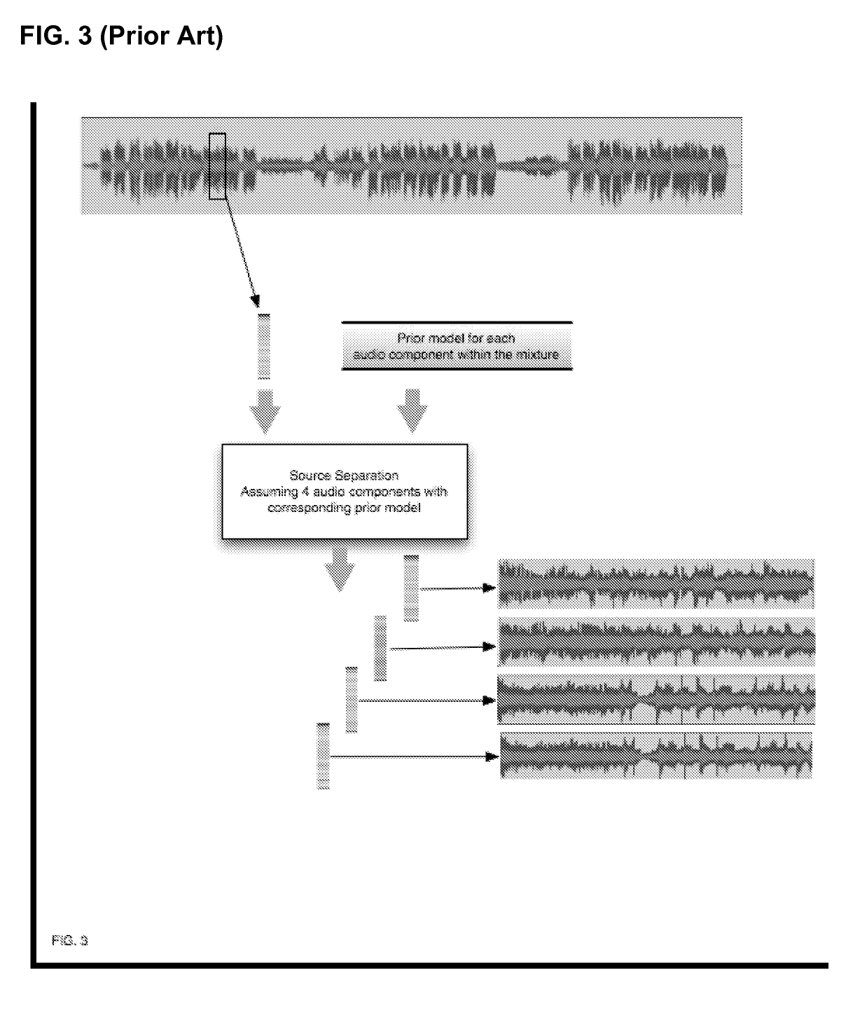

Referring to FIG. 3, a third prior art source separation system as described for instance in Benaroya] is shown. This system requires prior information about the sources within the mixture. This information can be very difficult to obtain. This system handles convolutive mixtures by assuming linear instantaneous mixing in each frequency band.

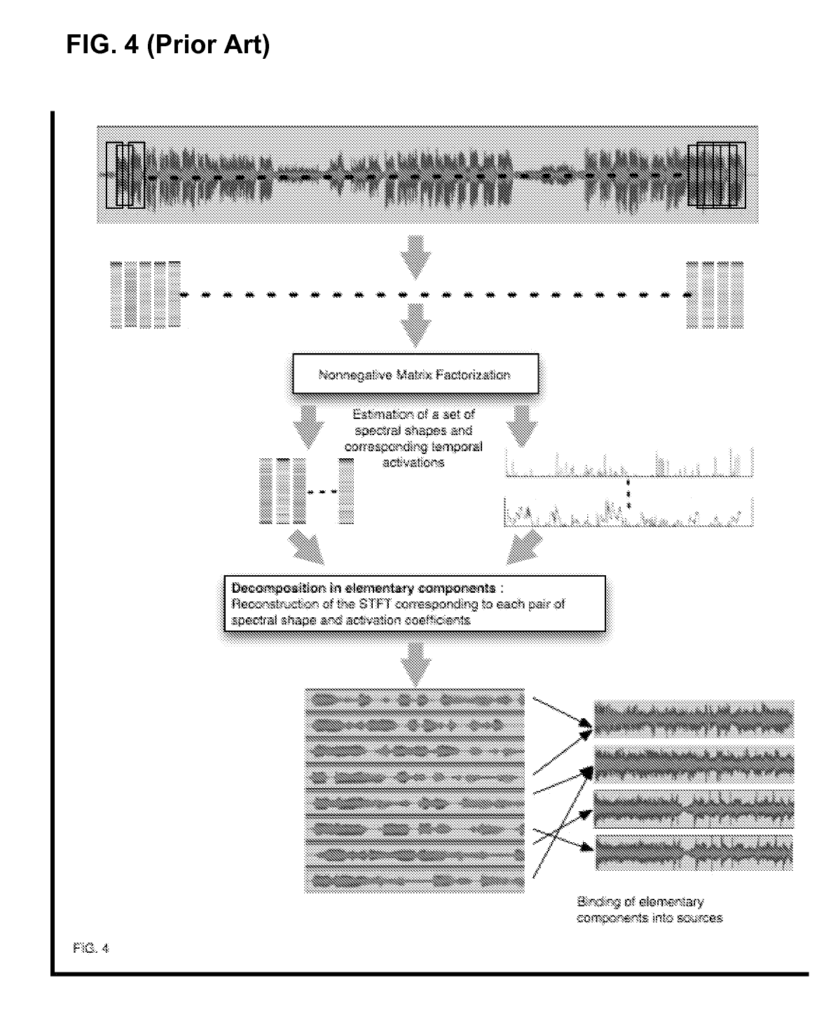

Referring to FIG. 4, a fourth prior art source separation system according to prior art described for instance in Wang is shown. No prior information is required but the algorithm is not able to take advantage of spatial diversity and does not take into account segmental information, thereby leading to poor performance and little potential enhancement. Moreover separated components do not correspond to an audio source and a manual binding of the elementary components is required.

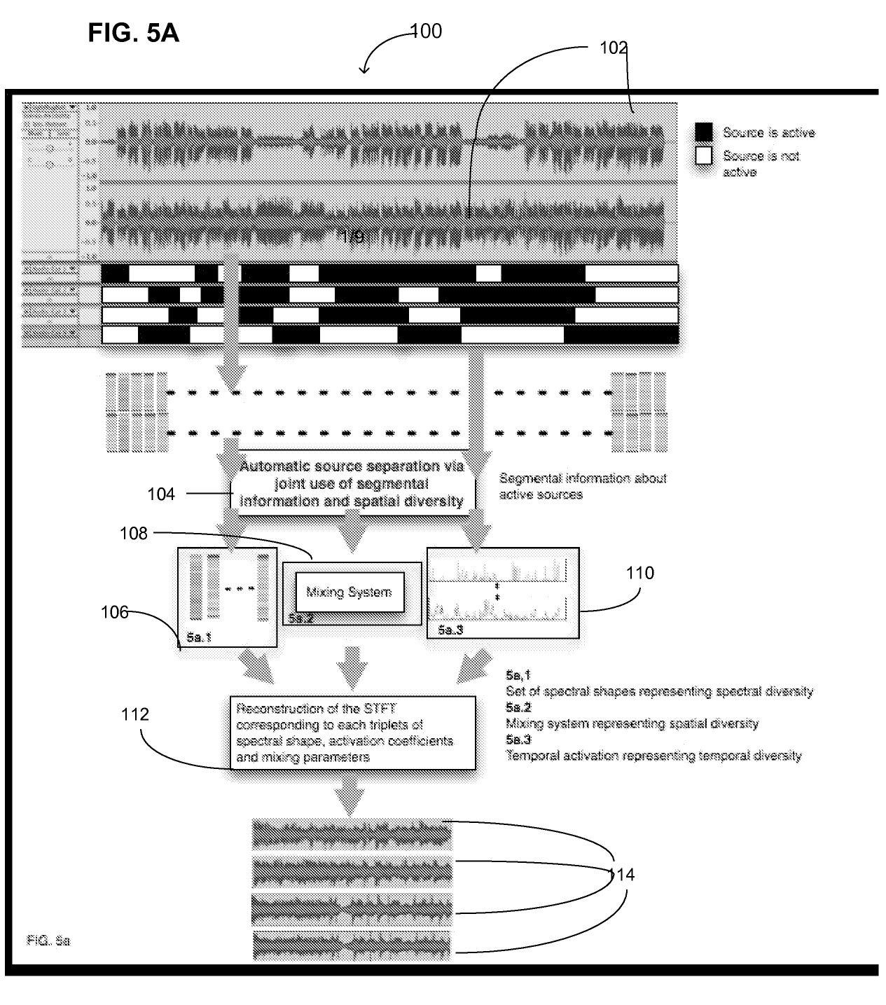

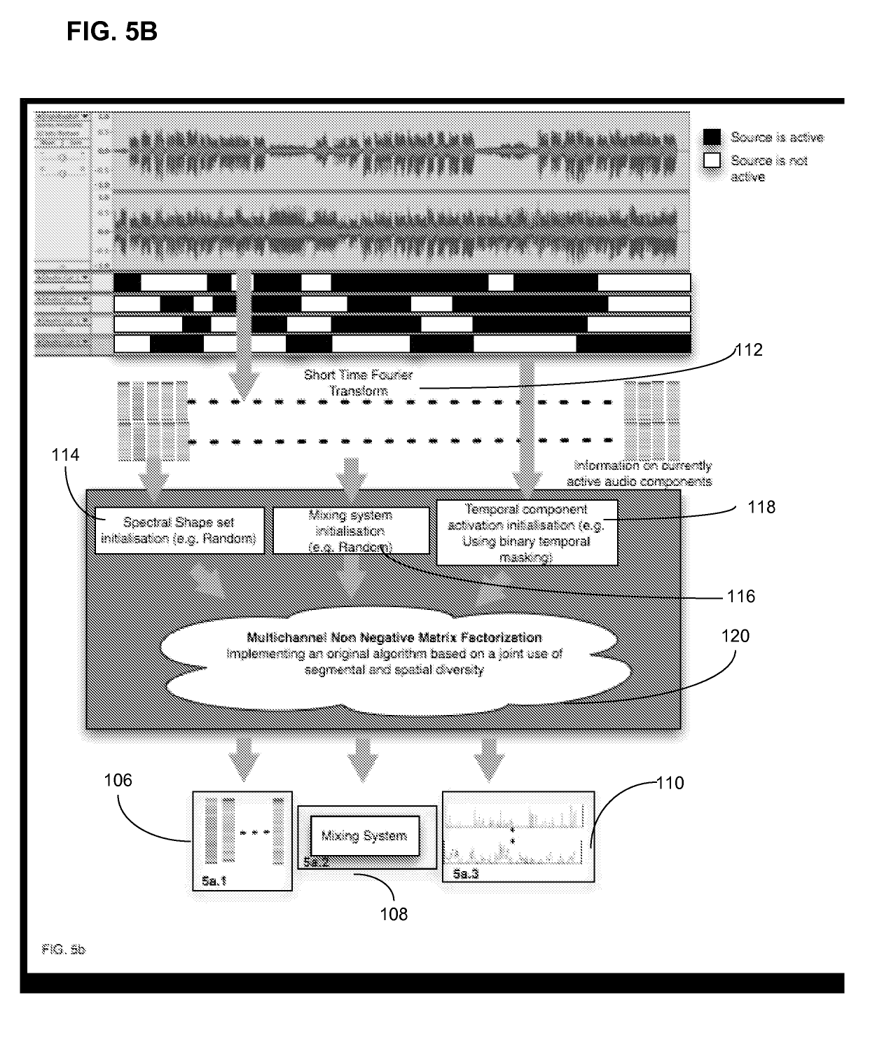

Referring to FIG. 5A, a source separation system 100 according to the present invention is shown. In system 100, no prior information on the spectral characteristics of the sources within the mixture is required. This system 100 is able to jointly take into account spectral and segmental sources diversity (mono recordings), or spatial, segmental and spectral sources diversity (for multi channels recordings) to efficiently estimate separated sources. Various sources such as sound sources 102 (only four shown) are subjected to an automatic source separation via a joint use of segmental information and spatial diversity block (104), wherein segmental information about some sources such as active sources is automatically provided.

Regarding source diversity, a set of spectral shapes (106) representing spectral diversity is provided using information derived from block (104).

Regarding source spatial diversity mixing parameters (108) representing spatial diversity are provided using information derived from block (104).

Regarding source energy variation, a temporal activation (110) representing temporal diversity is provided using information derived from block (104).

At a sampling range, first a set of spectral shapes (106), second the output of the mixing system (108), and third temporal activation (110) are processed. The above three are defined as a triplet. A triplet includes spectral shapes, activation coefficients, and mixing parameters.

The set of spectral shapes (106), the output of the mixing system (108), and temporal activation (110) are input respectively into a block 112, wherein a reconstruction of a STFT (Short Term Fourier Transform) corresponding to each source triplet among the set of triplets is performed. The sources are in turn separated 114 into their respective sources (only four shown).

Referring to FIG. 5B, an example of a set of source estimation blocks in accordance with the present invention is shown. Various sources such as sound sources 102 (only four shown) are subjected to a short term Fourier Transform 412 into the frequency domain. The transformed source information is further subjected to a set of initialization processes. For spectral shapes, initialization 414 such as random initialization is used. For mixing systems, initialization 416 such as random initialization is used. For temporal component activation, initialization 418 such as binary temporal masking is used. The initialized components are subjected to a multi-channel non-negative matrix factorization 420 by means of implementing an original algorithm based on a joint use of segmental and spatial diversity. This algorithm is described in Ozerov I.

The initialized information including spectral shapes (106), the output of the mixing system (108), and temporal activation (110) are formed as the result of the original algorithm based on a joint use of segmental and spatial diversity. As can be seen, the initialization problem is handled by the use of the activation information. Activation information informs on the presence/absence of each source at each instant.

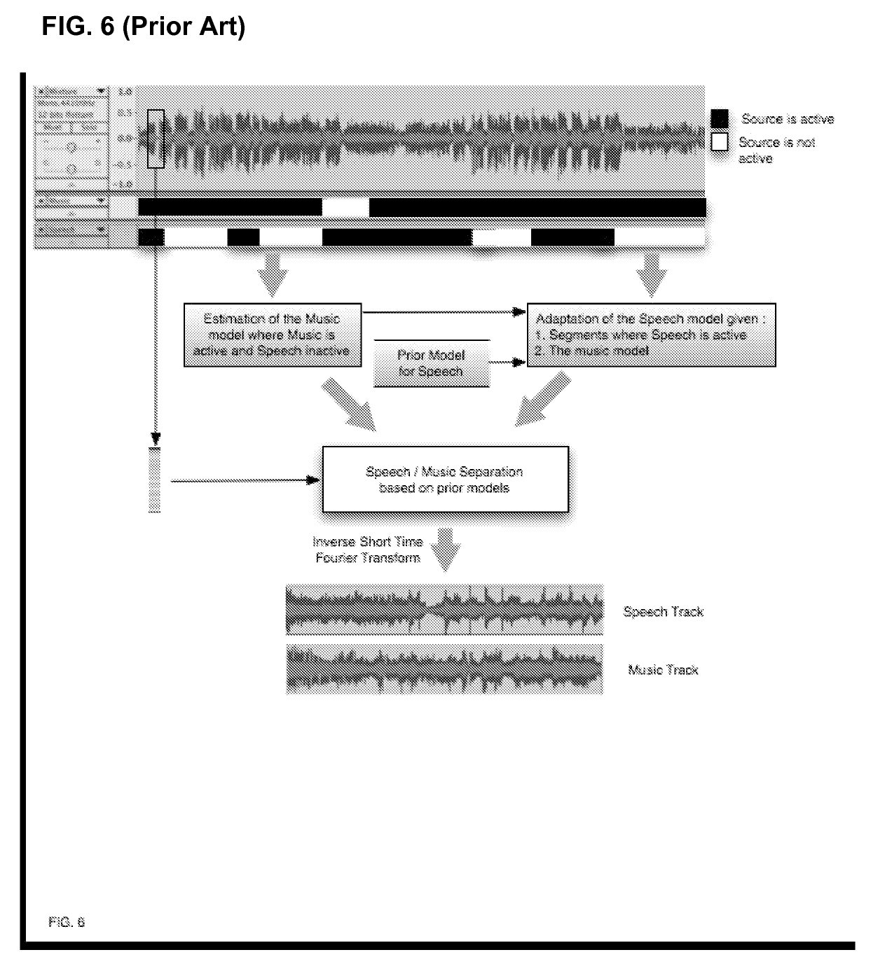

Referring to FIG. 6, a fifth prior art source separation system according to prior art described for instance in Ozerov II is shown. This system is limited to the separation of two sources. It requires prior segmental information on both sources. It estimates prior model of each source using segments where there is no more than one source active. Spectral and segmental information are sequentially taken into account and the proposed system is not able to take into account spatial diversity.

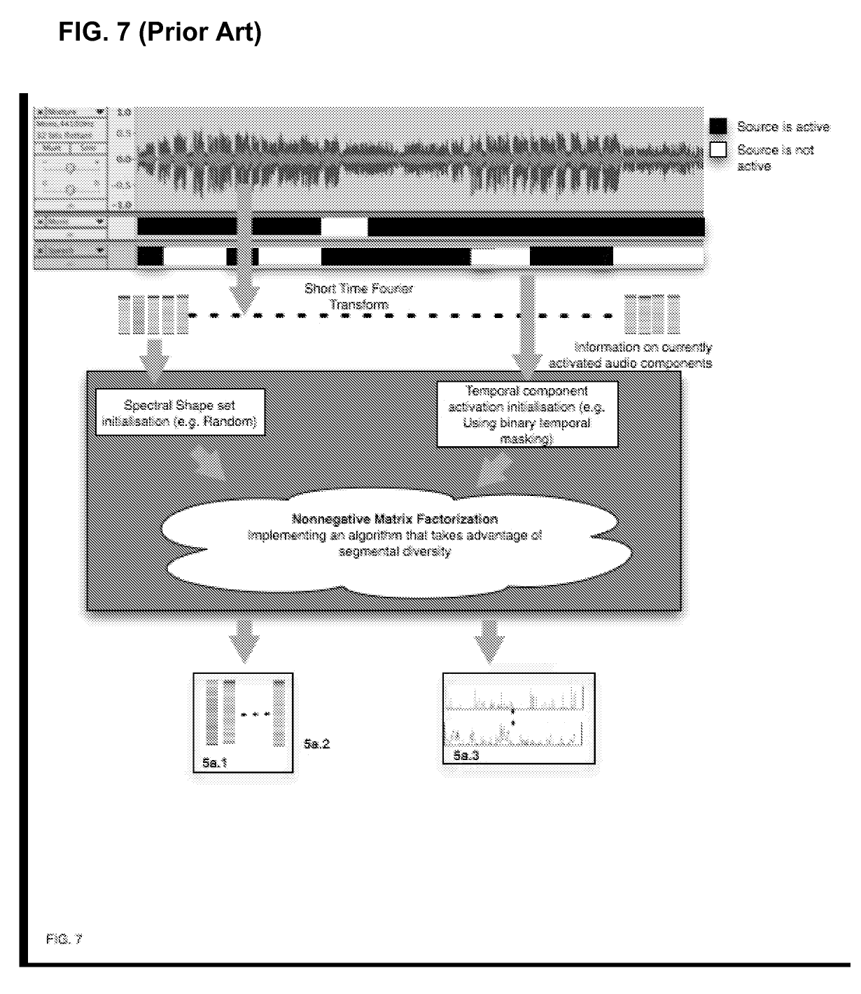

Referring to FIG. 7, an example of a sixth prior art source separation system according to prior art described for instance in Laurberg is shown. No prior information is required, the system is able to take advantage of sources' segmental and spectral diversities but it is limited by its inability to take advantage of spatial information. This drawback is overcome by the new source estimation algorithm of the proposed invention.

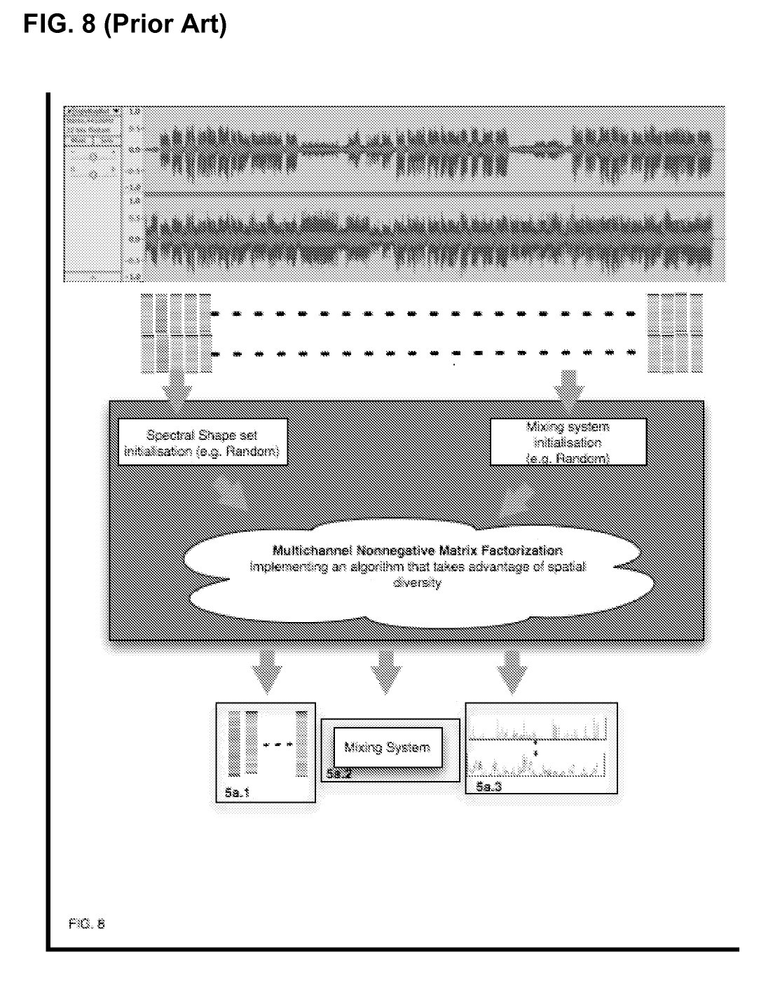

Referring to FIG. 8, an example of a seventh prior art source separation system according to prior art described for instance in Ozerov I is shown. No prior information is required, the system is able to take advantage of sources' spatial and spectral diversities but it is limited by its inability to take advantage of segmental information. This drawback is overcome by the new source estimation algorithm of the proposed invention.

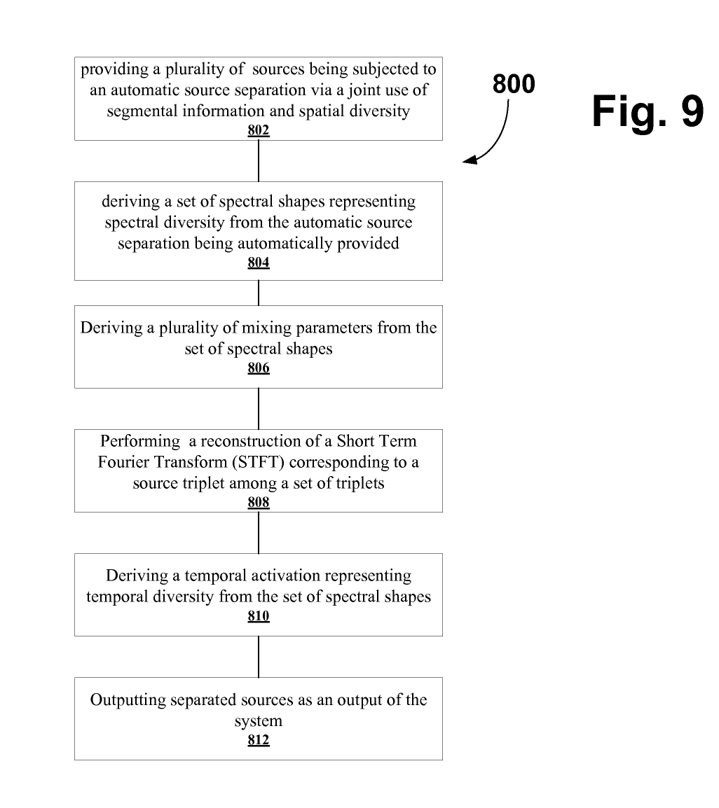

Referring to FIG. 9, a flowchart 800 of the present invention is shown. A method for source separation is shown in flowchart 800. A plurality of sources being subjected to an automatic source separation via a joint use of segmental information and spatial diversity is provided (Step 802). A set of spectral shapes representing spectral diversity is derived from the automatic source separation is automatically provided (Step 804). A plurality of mixing parameters is derived from the set of spectral shapes (Step 806). Within a sampling range, performing a Short Term Fourier Transform (STFT) corresponding to a source triplet among a set of triplets is reconstructed (Step 808). A temporal activation representing temporal diversity is derived from the set of spectral shapes (Step 810). Separated sources as an output of the system is outputted (Step 812).

The method, system and apparatus for source separation that are described in this document can apply to any type of mixture, either underdetermined or (over) determined, either instantaneous or convolutive.

Some of the embodiments are described herein as a method or combination of elements of a method that can be implemented by a processor of a computer system or by other means of carrying out the function of the present invention. Thus, a processor with the necessary instructions for carrying out such a method or element of a method forms a means for carrying out the method or element of a method associated with the present invention. Furthermore, an element described herein of an apparatus embodiment is an example of a means for carrying out the function performed by the element for the purpose of carrying out the invention. It will be understood that the steps of methods discussed are performed in one embodiment by an appropriate processor (or processors) of a processing (i.e., computer) system executing instructions stored in a storage. The term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors. It will also be understood that embodiments of the present invention are not limited to any particular implementation or programming technique and that the invention may be implemented using any appropriate techniques for implementing the functionality described herein. Furthermore, embodiments are not limited to any particular programming language or operating system.

The methodologies described herein are, in one embodiment, performable by one or more processors that accept computer-readable (also called machine-readable) logic encoded on one or more computer-readable media containing a set of instructions that when executed by one or more of the processors carry out at least one of the methods described herein. Any processor capable of executing a set of instructions (sequential or otherwise) that performs the functions or actions to be taken are contemplated by the present invention. Thus, one example is a typical processing system that includes one or more processors. Each processor may include one or more of a CPU, a graphics processing unit, or a programmable digital signal processing (DSP) unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., an liquid crystal display (LCD) or a cathode ray tube (CRT) display or any suitable display for a hand held device. If manual data entry is required, the processing system also includes an input device such as one or more of an alphanumeric input unit such as a keyboard, a pointing control device such as a mouse, stylus, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries logic (e.g., software) including a set of instructions to cause performing, when executed by one or more processors, one of more of the methods described herein. The software may reside in the hard disk, or may also reside, completely or at least partially, within the RAM and/or within the processor during execution thereof by the computer system. Thus, the memory and the processor also constitute computer-readable carrier medium on which is encoded logic, e.g., in the form of instructions.

Thus, one embodiment of each of the methods described herein is in the form of a computer-readable carrier medium carrying a set of instructions, e.g., a computer program that are for execution on one or more processors, e.g., one or more processors that are part of a communication network. Thus, as will be appreciated by those skilled in the art, embodiments of the present invention may be embodied as a method, an apparatus such as a data processing system, or a computer-readable carrier medium, e.g., a computer program product. The computer-readable carrier medium carries logic including a set of instructions that when executed on one or more processors cause the processor or processors to implement a method. Accordingly, the present invention may take the form of a method, an entirely hardware embodiment, an entirely software embodiment or an embodiment combining software and hardware. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, (i) in one set of embodiment, a tangible computer-readable medium, e.g., a solid-state memory, or a computer software product encoded in computer-readable optical or magnetic media; (ii) in a different set of embodiments, a medium bearing a propagated signal detectable by at least one processor of one or more processors and representing a set of instructions that when executed implement a method; (iii) in a different set of embodiments, a carrier wave bearing a propagated signal detectable by at least one processor of the one or more processors and representing the set of instructions a propagated signal and representing the set of instructions; (iv) in a different set of embodiments, a transmission medium in a network bearing a propagated signal detectable by at least one processor of the one or more processors and representing the set of instructions.

In the foregoing specification, specific embodiments of the present invention have been described. However, one of ordinary skill in the art appreciates that various modifications and changes can be made without departing from the scope of the present invention as set forth in the claims below. For example, the therapeutic light source and the massage component are not limited to the presently disclosed forms. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A source separation system, comprising:
a plurality of sources being subjected to an automatic source separation via a joint use of segmental information and spatial diversity;
a set of spectral shapes representing spectral diversity derived from the automatic source separation being automatically provided;
a plurality of mixing parameters derived from the set of spectral shapes; and
within a sampling range, a triplet is processed wherein a reconstruction of a Short Term Fourier Transform (STFT) corresponding to a source triplet among the set of triplets is performed.

2. The source separation system of claim 1 further comprising a temporal activation representing temporal diversity derived from the set of spectral shapes.

3. The source separation system of claim 1 further comprising separated sources as an output of the system.

4. The source separation system of claim 1, wherein the triplet comprises spectral shapes, activation coefficients, and mixing parameters.

5. The source separation system of claim 1, wherein the segmental information about some sources is automatically provided.

6. The source separation system, wherein the plurality of sources is a plurality of sound sources.

7. A method for source separation, comprising the steps of:
providing a plurality of sources being subjected to an automatic source separation via a joint use of segmental information and spatial diversity;
deriving a set of spectral shapes representing spectral diversity from the automatic source separation being automatically provided;
deriving a plurality of mixing parameters from the set of spectral shapes; and
within a sampling range, performing a reconstruction of a Short Term Fourier Transform (STFT) corresponding to a source triplet among a set of triplets.

8. The method of claim 7 further comprising the step of deriving a temporal activation representing temporal diversity from the set of spectral shapes.

9. The method of claim 7 further comprising outputting separated sources as an output of the system.

10. The method of claim 7, wherein the source triplet comprises spectral shapes, activation coefficients, and mixing parameters.

11. The method of claim 7, wherein the segmental information about some sources is automatically provided.

12. The method of claim 7, wherein the plurality of sources is a plurality of sound sources.
